(19) United States
(12) Patent Application Publication
(10) Pub. No.: US 2025/0328827 A1
(43) Pub. Date: Oct. 23, 2025

(54) METHOD FOR EFFICIENT PACKING OF TWO-DIMENSIONAL IRREGULAR PATTERNS VIA EXPANDED AREAS OVERLAP OPTIMIZATION AND DYNAMIC ITERATION

(71) Applicant: NANJING TECH UNIVERSITY, Nanjing City (CN)

(72) Inventors: Longhui MENG, Nanjing City (CN); Yunkai PU, Nanjing City (CN); Xiaomeng WANG, Nanjing City (CN); Hua WANG, Nanjing City (CN); Hao ZHANG, Nanjing City (CN); Rongjing HONG, Nanjing City (CN)

(21) Appl. No.: 19/078,924

(22) Filed: Mar. 13, 2025

(30) Foreign Application Priority Data
Apr. 17, 2024 (CN) 2024104637900

(51) Int. Cl. G06Q 10/04; G06N 3/126; G06V 10/46

(52) U.S. Cl. CPC G06Q 10/043; G06N 3/126; G06V 10/467

(57) ABSTRACT

A method for efficient packing of two-dimensional irregular patterns via expanded areas overlap optimization and dynamic iteration is provided. This method focuses on optimizing layout efficiency and improving material utilization when arranging irregular two-dimensional parts on plates. By obtaining binarized images from the AutoCAD drawings, sorting pattern images by size, and performing a series of expansions, an improved genetic algorithm is used to optimize the positioning of pattern images on the plate. The optimization target is to maximize the overlap rate between the expanded area from the second expansion of the current pattern image and the expanded area of the plate image, as well as the already arranged pattern images.

### CROSS-REFERENCE TO RELATED APPLICATIONS

This application claims priority to Chinese Patent Application No. 202410463790.0, filed on Apr. 17, 2024, the contents of which are hereby incorporated by reference.

### TECHNICAL FIELD

The present disclosure relates to a method for efficient packing of two-dimensional irregular patterns via expanded areas overlap optimization and dynamic iteration, which belongs to the field of computer science and engineering.

### BACKGROUND

In the fields of manufacturing and engineering design, especially in industries such as metal processing, garment manufacturing and aerospace parts production, efficient packing of two-dimensional parts is critical for enhancing material utilization, minimizing costs, and boosting production efficiency. Traditionally, the method for packing these parts relies on simple geometric alignments and manual optimizations. While this approach may suffice for straightforward shapes and small quantities, it becomes less effective as the complexity of the parts and the number of parts increase.

The existing two-dimensional parts packing technology faces many challenges. Traditional methods often fail to account for the complex interactions between parts, including maintaining minimum gaps, the impact of part rotation on material utilization, and addressing irregular part shapes. Secondly, the existing technology lacks an effective dynamic iterative mechanism, and it is impossible to adaptively adjust the strategy to find the optimal solution in the packing process. In addition, many existing algorithms are inefficient when dealing with a large number of parts, and it is difficult to meet the needs of rapid production.

In view of these problems, the disclosure provides a method for efficient packing of two-dimensional irregular patterns via expanded areas overlap optimization and dynamic iteration. The goal of this method is to further improve the packing efficiency while ensuring high material utilization rate, especially for complex shape and packing tasks with a large number of parts.

### SUMMARY

The present disclosure relates to a method for efficient packing of two-dimensional irregular patterns via expanded areas overlap optimization and dynamic iteration, which optimizes the packing of irregular two-dimensional parts on a plate, and further improves the packing efficiency while improving the utilization rate of the plate.

The present disclosure adopts the following technical scheme: a method for efficient packing of two-dimensional irregular patterns via expanded areas overlap optimization and dynamic iteration, and the packing process mainly includes the following steps:
S1, extracting pattern images from AutoCAD drawings, and converting these images to a binary format, wherein black represents the background and white represents the part area;
S2, obtaining transverse dimensions (Lₕ) and longitudinal dimensions (Lᵥ) of the parts;
S3, based on the sum of the transverse dimensions (Lₕ) and longitudinal dimensions (Lᵥ) of the parts, denoted as Lₜ, the pattern images are sorted from the largest to the smallest;
S4, expanding the pattern images for the first time according to gap requirements between the parts;
S5, calculating the width value w₂ according to the dimensions of the parts, and expanding the pattern images for the second time based on the value of w₂;
S6, selecting the top N pattern images from the sorted list based on a predetermined maximum value, Nₘₐₓ, to form a group of images;
S7, expanding the plate image by the same width (w₂) as the corresponding pattern image before the packing optimization process for each pattern image;
S8, employing an improved genetic algorithm to encode, mutate, and decode the placement positions of each pattern image within the selected group onto the plate image, and calculating the overlap rate between the expanded area from the second expansion of the current pattern image, the expanded area of the plate image, and the already arranged pattern images;
S9, selecting the pattern image with the highest overlap rate and placing it on the plate images according to the specified optimized position, and removing the corresponding pattern image from the previous image sequence;
S10, repeating the above steps of S6-S9 until all the pattern images have been placed on the board image.

In the described step S5, the corresponding dimensional principle specifies that: within each selected group of pattern images, the dimension Li of the last part, which is the smallest part, must not be less than α times the dimension of the first part, which is the largest part.

In the described step S5, after arranging each image, a new group of images needs to be selected and the overlap rate of the expanded areas of each pattern image in this group must be recalculated.

The beneficial effects of present disclosure include a departure from the traditional approach of simply optimizing the arrangement of pattern images based on size. While the overall strategy still involves ordering by size from the largest to the smallest, the specific arrangement of each part is further guided by the overlap rate of the expanded areas.

The core of the present disclosure lies in employing a dynamic iterative strategy combined with an optimized overlap rate mechanism for expanded areas. By conducting precise analysis of the pattern images extracted from AutoCAD drawings, this method effectively handles the irregularities in part shapes and their rotational requirements. By dynamically adjusting the arrangement and orientation of the pattern images and continuously optimizing the overlap rate of their expanded areas during the iteration process, this method not only reduces material waste but also ensures a compact and efficient arrangement of the parts.

This disclosure employs an improved genetic algorithm to optimize the arrangement of parts. By encoding, mutating, and decoding the positions of pattern images and integrating the overlap rate of the expanded areas as the optimization target, this method can find a near-optimal arrangement in a relatively short time. Furthermore, by dynamically adjusting the search range and parameter settings, the disclosure can adapt to arrangement tasks of varying complexity, providing flexible and effective solutions.

Another innovation of the present disclosure lies in the precise control of the gaps between patterns and their expanded areas. This approach not only effectively reduces material waste but also accounts for material removal during the cutting process.

Overall, the two-dimensional part arrangement method proposed by present disclosure, based on dynamic iteration and overlap optimization of expanded areas, represents a significant improvement over existing technologies. It is not only capable of effectively addressing the challenges of arranging complex two-dimensional parts but also significantly enhances material utilization and production efficiency, offering broad application prospects and practical value. Through present disclosure, enterprises in the manufacturing and engineering design sectors will be able to reduce waste, lower costs, and enhance the competitiveness of their products.

### BRIEF DESCRIPTION OF THE DRAWINGS

FIG. 1A shows the binarization of the original image of a schematic diagram of an image pre-adjustment preparation process.

FIG. 1B shows the schematic diagram of the image cropping process.

FIG. 1C shows the corresponding cropped image.

FIG. 2A shows the identification of the expanded area of the pattern image.

FIG. 2B shows the visualization of the pattern image after expanding process.

FIG. 3A shows the result of initial expansion of the pattern image.

FIG. 3B shows the result of subsequent expansion of the pattern image.

FIG. 3C shows the expanded area of the image.

FIG. 4A shows the schematic diagram of plate image before expanding.

FIG. 4B shows the schematic diagram of plate image after expanding.

FIG. 5 shows a schematic diagram of pattern dimension.

FIG. 6 shows a schematic diagram of binary coding in genetic algorithm.

FIG. 7 shows a schematic diagram of the dimension and position of the pattern.

FIG. 8 shows a flow chart of the theoretical framework for pattern packing.

FIG. 9A shows a schematic diagram of pattern 1.

FIG. 9B shows a schematic diagram of pattern 2.

FIG. 9C shows a placement of two patterns with overlap.

FIG. 9D shows the placement of two patterns without overlap.

FIG. 10A shows the random position of the pattern on the plate image.

FIG. 10B shows the corresponding expanded area position.

FIG. 10C shows an overlap area in the expanded area.

FIG. 10D shows the optimization result for the position of the expanded area.

FIG. 10E shows the optimized position of the corresponding pattern.

FIG. 11A shows the optimized position of the first pattern in the first group.

FIG. 11B shows the optimized position of the second pattern in the first group.

FIG. 11C shows the optimized position of the third pattern in the first group.

FIG. 11D shows the optimized position of the fourth pattern in the first group.

FIG. 11E shows the first pattern determined to be placed on the plate.

FIG. 12A shows the optimized position of the first pattern in the second group.

FIG. 12B shows the optimized position of the second pattern in the second group.

FIG. 12C shows the optimized position of the third pattern in the second group.

FIG. 12D shows the first two patterns determined to be placed on the plate.

FIG. 13A shows the optimized position of the first pattern in the third group.

FIG. 13B shows the optimized position of the second pattern in the third group.

FIG. 13C shows the first three patterns determined to be placed on the plate.

FIG. 14A shows a schematic showing the width occupied by the first two patterns on the plate image.

FIG. 14B shows the permissible range for placing the third pattern within the occupied area.

FIG. 15 shows a schematic diagram showing the expansion of the width of the searching area.

FIG. 16A shows the packing result of the first group of patterns based on iterative overlap optimization.

FIG. 16B shows the packing result of the first group of patterns based on non-iterative overlap optimization.

FIG. 16C shows the packing result of the second group of patterns based on iterative overlap optimization.

FIG. 16D shows the packing result of the second group of patterns based on non-iterative overlap optimization.

### DETAILED DESCRIPTION OF THE EMBODIMENTS

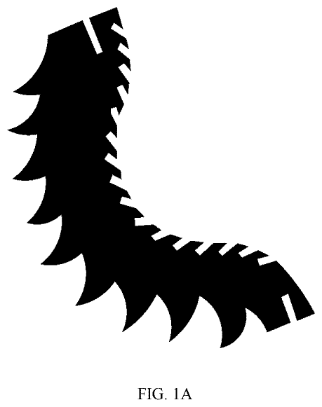

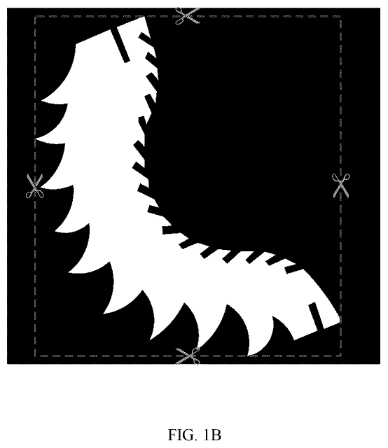

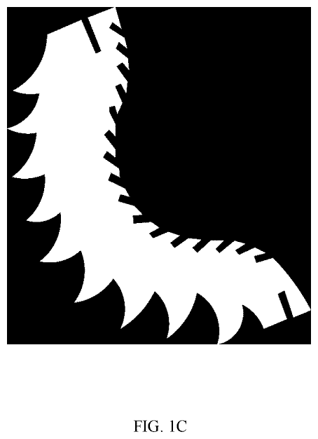

The present disclosure will be further described with reference to FIG. 1A-FIG. 16D.

The present disclosure adopts the following technical scheme: a method for efficient packing of two-dimensional irregular patterns via expanded areas overlap optimization and dynamic iteration, and the packing process mainly includes the following steps:
S1, extracting pattern images from AutoCAD drawings, and converting these images to a binary format, wherein black represents the background and white represents the part area.
S2, obtaining the transverse dimension (Lₕ) and longitudinal dimension (Lᵥ) of the parts.
S3, sorting the pattern images from the largest to the smallest based on the sum of the transverse dimension (Lₕ) and longitudinal dimension (Lᵥ) of the parts, denoted as Lₜ.
S4, expanding the pattern images for the first time based on the gap requirements between the parts;
S5, calculating the width value w₂ of the corresponding expanded area based on the dimensions of the parts, and performing the second expansion of the pattern images;
S6, based on the predetermined value (Nₘₐₓ) and the corresponding dimensional principles, selecting the top N pattern images to form a group of images.
S7, expanding the plate image by the same width (w₂) as the corresponding pattern image before the packing optimization process for each pattern image;
S8, employing an improved genetic algorithm to encode, mutate, and decode the placement positions of each pattern image within the selected group onto the plate image, and calculating the overlap rate between the expanded area from the second expansion of the current pattern image, the expanded area of the plate image, and the already arranged pattern images;
S9, selecting the pattern image with the highest overlap rate and arranging it on the plate image in the specified optimized position, then removing this image from the previous image sequence;
S10, repeating the above steps S6-9 until all parts have been arranged.

In the described step S5, the corresponding dimensional principle stipulates that in each selected group of pattern images, the dimension (Lₜ) of the last part, which is the smallest part, must not be less than α times the dimension of the first part, which is the largest part.

In the described step S5, after arranging each image, a new group of images must be selected and the overlap rate of the expanded areas for each image in this group must be recalculated.

### Image Preprocessing

### (1) Image Cropping and Size Adjustment

The corresponding two-dimensional pattern images are extracted from DWG files generated by AutoCAD software using the C++ programming language. Subsequently, based on the color difference between the target objects and the background in the image, the images are binarized as shown in FIG. 1A.

Typically, the corresponding pattern images do not accurately reflect the true dimensions of the objects. Therefore, it is necessary to adjust the size of the images proportionally. This process begins with trimming the edges of the image, as shown in FIG. 1B and FIG. 1C. Subsequently, the image is resized to accurately match the actual dimensions of the workpiece.

After resizing the image to accurately match the actual dimensions of the part, it is then pasted onto another image with a black background.

### (2) Image Expanding

During the process of packing the parts, the gaps between them are crucial, as the cutting tool has a specific size and will remove some material during the cutting stage. To address this issue, the pattern images are appropriately expanded based on Formula (1).

$$\{ \begin{matrix}I ( i , j ) = 1 if {( i - a )}^{2} + {( j - b )}^{2} \leq [ {( g / 2 + 1 )}^{2} - 1 ] and I ( a , b ) = 1 , \\ I ( i , j ) = 0 others .\end{matrix} \qquad ( 1 )$$

Here, “g” represents the gap distance between different parts.

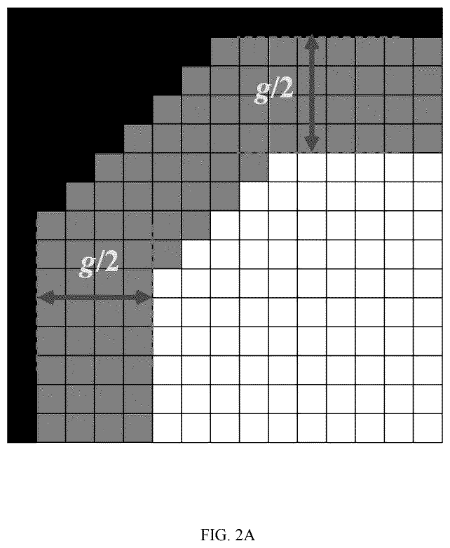

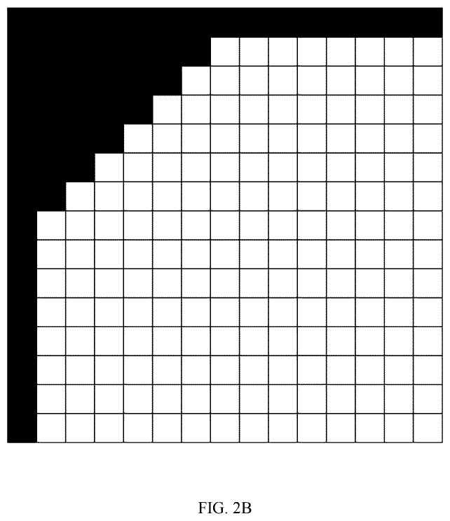

Here, the packing accuracy is set to 0.5 mm, so each pixel corresponds to a dimension of 0.5 mm. Additionally, the gap between parts is set to a 4 mm clearance. The process of image expansion is illustrated in FIG. 2A-FIG. 2B.

In FIG. 2A, white pixels represent the target objects, gray pixels represent pixels within the expanded area, and black pixels represent the background. When the position of any pixel satisfies Formula (1), the pixel will be converted to white. The expanded image is shown in FIG. 2B.

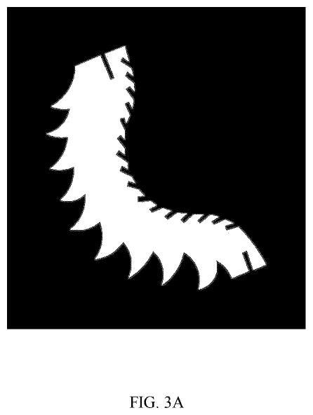

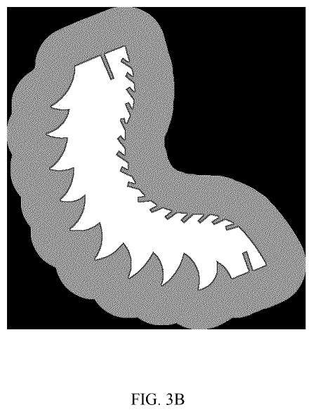

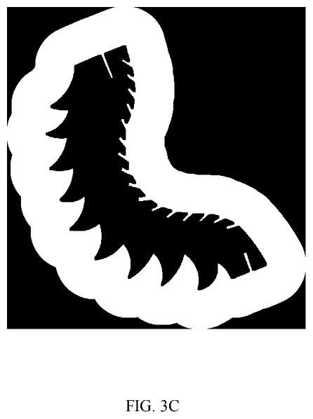

The expanded image is shown in FIG. 3A, with the expanded area represented in gray. The fundamental principle of pattern layout optimization is primarily based on the overlap ratio of the subsequent expanded areas, which includes overlaps with other patterns and the expanded areas of the plate image. This concept will be discussed more comprehensively later. Therefore, it is necessary to further expand the pattern images based on the initial expansion. Formula (2) defines the width of the expansion area for subsequent expansions:

$${w}_{2} = round [ ( {L}_{length} + {L}_{width} ) / 13 ] \qquad ( 2 )$$

where L_{length} and L_{width} represent the length and width of the pattern images, respectively. As the size of the pattern decreases, the width of the expansion area, w₂, correspondingly decreases. The minimum value of w₂ is set to 15, which can be described as follows:

$${w}_{2} = max ( {w}_{2} , 15 ) \qquad ( 3 )$$

This expression ensures that the pattern images retain sufficient area for layout optimization calculations.

The first stage of image expansion is shown in FIG. 3A, with the expanded area highlighted in gray. The next stage of expansion is shown in FIG. 3B, where the expanded area is represented in light gray. The portion expanded during the second stage, as shown in FIG. 3C, is specifically used for the subsequent layout optimization process.

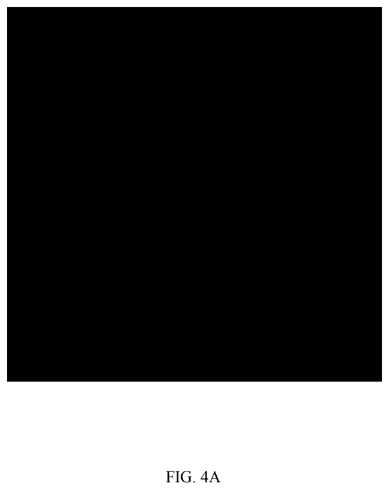

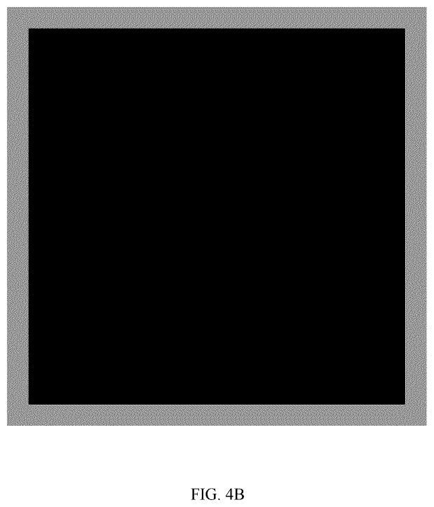

As shown in FIG. 4A, the plate image also needs to undergo an expansion process, with the width of the expanded area being the same as that of the corresponding pattern image, as illustrated in FIG. 4B. In this figure, the black area represents the plate, while the gray area indicates the expanded region. Although this expanded area does not physically exist, it is specifically used for the pattern layout optimization process. Since the width of the expanded areas varies between different patterns, the expansion of the plate image should be performed prior to the layout optimization of each pattern image.

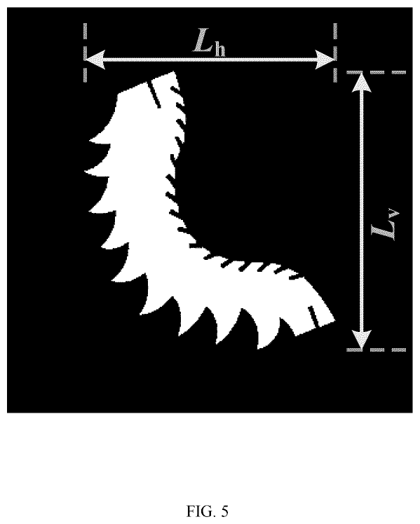

The arrangement of pattern images generally follows the order from the largest to the smallest in terms of size, where Lₕ and Lᵥ represent the horizontal and vertical dimensions, respectively, as shown in FIG. 5.

All pattern images designated for layout are sorted based on their size Lₜ, which is defined as follows:

$${L}_{t} = {L}_{h} + {L}_{v} \qquad ( 4 )$$

### Improved Genetic Algorithm

### (1) Coding

Here, an improved genetic algorithm is used to determine the optimal spatial arrangement of parts. The positional characteristics of these patterns in the image are defined by three parameters: x-coordinate, y-coordinate, and rotation angle. These data are initially encoded in a binary system.

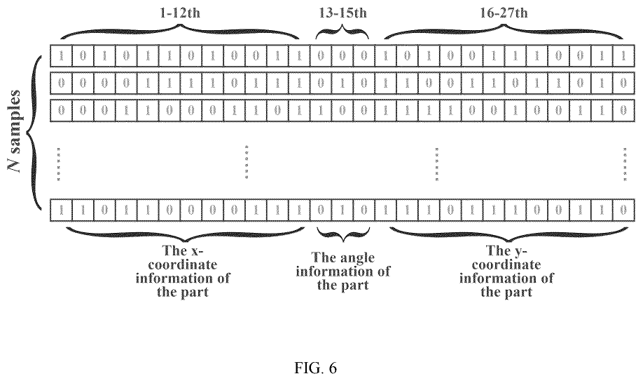

The binary encoding consists of a total of 27 bits. The first 12 bits represent the x-coordinate of the pattern, followed by bits 13 to 15, which specify the rotation angle of the pattern. Subsequently, bits 16 to 27 represent the y-coordinate of the component. This encoding process is illustrated in FIG. 6.

### (2) Mutation

In terms of mutation, the value of specific binary bits is toggled, switching from 0 to 1, or vice versa. A parameter named Nrₘₐₓ is introduced here. The encoding of a given sample is denoted as SC, where |SC|₁ represents the number of ‘1’s in the encoding SC, and |SC|₀ represents the number of ‘0’s. Referring to FIG. 6, the following insights can be derived:

$${\vert SC \vert}_{1} + {\vert SC \vert}_{0} = 27 \qquad ( 5 )$$

The value of Nrₘₐₓ is randomly determined as either |SC|₁ or |SC|₀, as shown in the following formula:

$${Nr}_{max} ϵ \{ {\vert SC \vert}_{1} , {\vert SC \vert}_{0} \} \qquad ( 6 )$$

The number of bits requiring mutation is represented by Nr, with its maximum allowable value being Nrₘₐₓ. The exact value of Nr is chosen within the range of 0 to Nrₘₐₓ. This relationship can be described as follows:

$$Nr ϵ \{ 0 , 1 , 2 , … , {Nr}_{max} \} \qquad ( 7 )$$

In addition, a random variable r is used to determine the exact bit to be modified during the mutation phase. The value of r is set within the range of 1 to 27 and can be expressed as follows:

$$r ϵ \{ 1 , 2 , 3 , … , 27 \} \qquad ( 8 )$$

### (3) Decoding

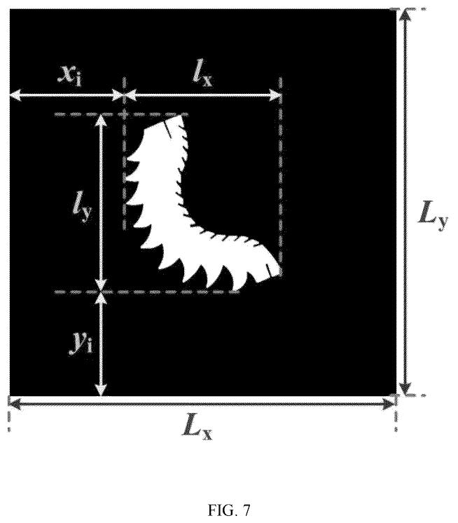

The values of the part's x-coordinate (xᵢ) and y-coordinate (yᵢ) must fall within the specified range to ensure that the part's position is on the plate. This can be expressed as:

$$\{ \begin{matrix}{x}_{i} ∈ [ 0 , {L}_{x} - {l}_{x} ] \\ {y}_{i} ∈ [ 0 , {L}_{y} - {l}_{y} ]\end{matrix} \qquad ( 9 )$$

where Lₓ and L_{y} represent the dimensions of the search area along the X-axis and Y-axis, respectively. Additionally, Iₓ and I_{y} represent the part dimensions along the X-axis and Y-axis, respectively, as shown in FIG. 7.

Considering that a 12-bit binary number can represent 212=4096 different combinations of information, and a 3-bit binary number can represent 23-8 different combinations, the spatial attributes of the pattern are defined by a 27-bit binary sequence as follows:

$${x}_{i} = BIN ( 1 : 12 ) \cdot ( {L}_{x} - {l}_{x} ) / 4096 \qquad ( 10 )$$

$${y}_{i} = BIN ( 16 : 27 ) \cdot ( {L}_{y} - {l}_{y} ) / 4096 \qquad ( 11 )$$

$$θ = BIN ( 13 : 15 ) \cdot 45 \qquad ( 12 )$$

where ‘BIN’ refers to the 27-bit binary code assigned to each sample, succinctly capturing the numerical attributes associated with each sample.

### Iterative Overlap Optimization Placement (IOOP)

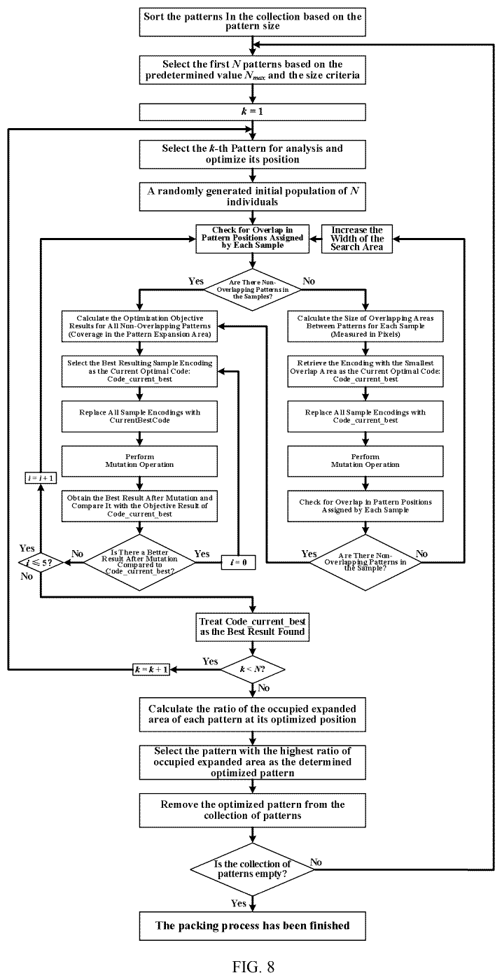

FIG. 8 shows a detailed flowchart of the corresponding part packing principle, providing a comprehensive explanation of the key steps in the search method used in present disclosure. The process begins by sorting the patterns based on their dimensions, as shown in FIG. 7. Subsequently, the initial N patterns are selected according to the set value Nₘₐₓ and the specific dimensional criteria in Formula (18). The placement of each pattern is optimized using the improved genetic algorithm outlined in this document. Among these N patterns, an evaluation and comparison are conducted, and the pattern with the highest overlap ratio is selected for layout. The following sections of this document will provide a detailed discussion of each step presented in the flowchart, thoroughly exploring the algorithm strategies implemented for optimization.

### (1) Overlap Detection

Avoiding overlap between part patterns during the layout process is crucial. In this regard, we propose a simple and efficient technique that uses the total number of white pixels in the image as a mechanism to identify potential overlaps.

### Formula (13) Establishes the Criteria to be Satisfied:

$${N}_{white\_total} = {N}_{white 1} + {N}_{white 2} \qquad ( 13 )$$

where N_{white_total} represents the cumulative count of white pixels in the combined image IMG, while N_{white1} and N_{white2} reflect the number of white pixels in images IMG1 and IMG2, respectively. The calculation of these values is described as follows:

$${N}_{white\_total} = {\sum }_{i = 1}^{M} {\sum }_{j = 1}^{N} IMG ( i , j ) \qquad ( 14 )$$

$${N}_{white 1} = {\sum }_{i = 1}^{M} {\sum }_{j = 1}^{N} {IMG}_{1} ( i , j ) \qquad ( 15 )$$

$${N}_{white 2} = {\sum }_{i = 1}^{M} {\sum }_{j = 1}^{N} {IMG}_{2} ( i , j ) \qquad ( 16 )$$

By comparing the white pixel counts, it is possible to identify whether there is overlap between patterns. If Formula (13) is not satisfied, it indicates that overlap exists between the patterns, and they should be excluded from consideration.

The target object of the pattern is represented by white pixels, while the background pixels are black. The combined image, denoted as IMG, is expressed by Formula (17) as follows:

$$IMG = {IMG}_{1} \vert {IMG}_{2} \qquad ( 17 )$$

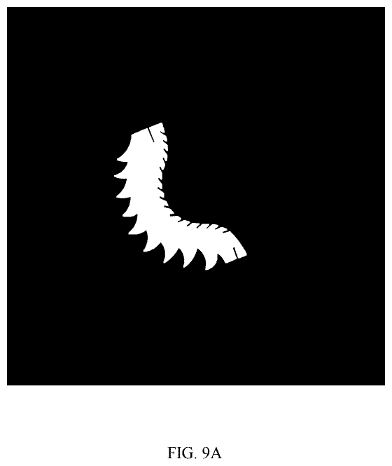

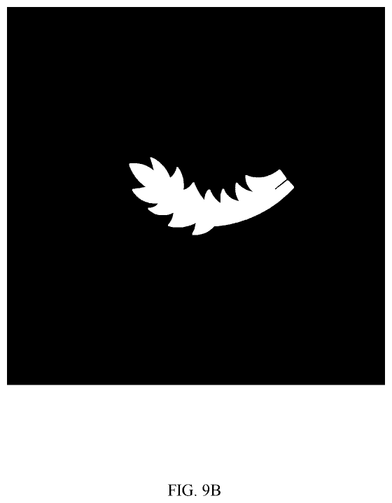

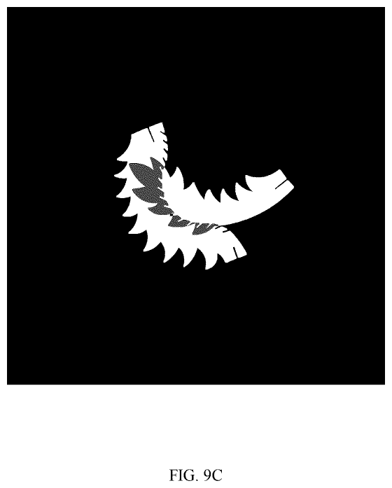

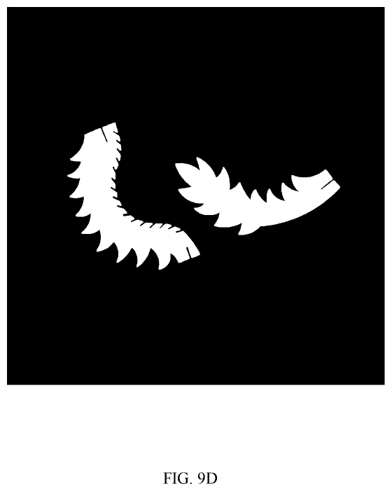

The entire process is visualized in FIG. 9A-FIG. 9D. Notably, FIG. 9C shows the resulting pattern formed by combining the patterns shown in FIG. 9A and FIG. 9B.

FIG. 9C clearly shows the overlap between two patterns, with the overlapping area marked in gray. In contrast, FIG. 9D displays two patterns without any overlap, which are distinctly separated from each other, thereby satisfying the conditions of Formula (13).

### (2) Overlap Optimization

For pattern placement, it is initially critical to ensure that the entire pattern is contained within the boundaries of the plate. This requirement is confirmed by Formulas (10)-(12), which guarantee that any values obtained for the pattern's x-coordinate (x_{c}), y-coordinate (y_{c}), and rotation angle comply with this limitation. Secondly, as previously emphasized, avoiding overlap between patterns is essential. The theory guiding pattern position optimization focuses on the overlap ratio of the expanded areas of the patterns. This expanded area is represented by the light gray region shown in FIG. 3B.

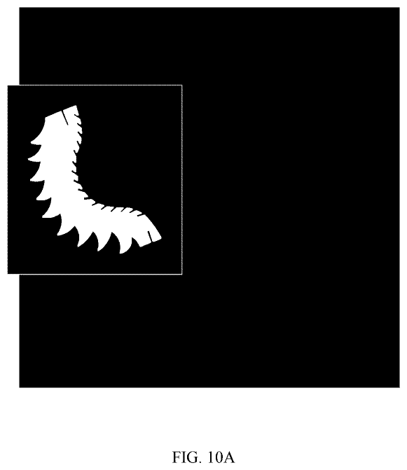

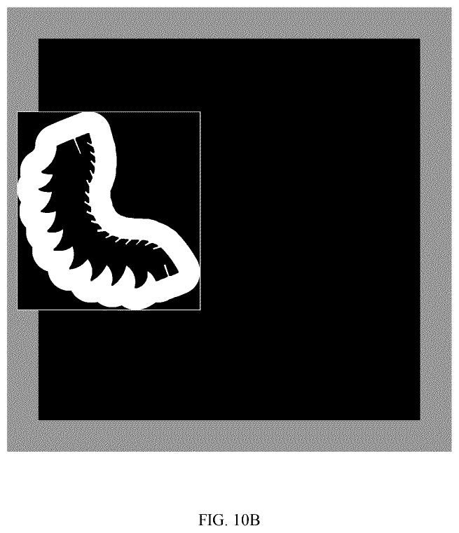

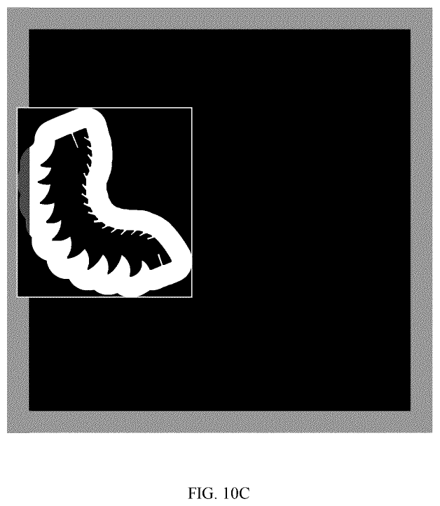

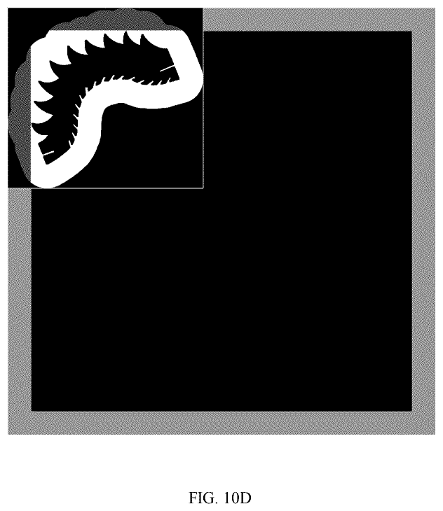

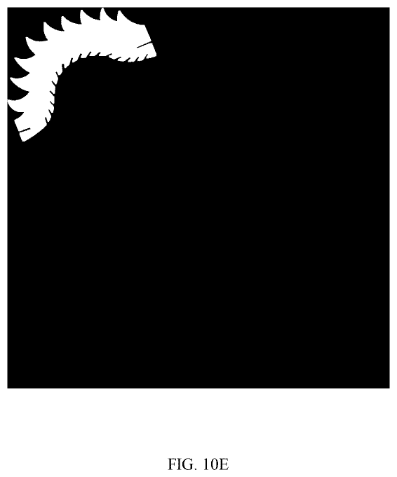

FIG. 10A shows a random placement of a pattern on the plate image, corresponding to the position of the expanded area shown in FIG. 10B. The overlap area between the expanded area of the pattern and the expanded area of the plate (the light gray area at the edge of the plate image) is highlighted in dark gray, as illustrated in FIG. 10C. It is evident that this position is not the optimized result. After five consecutive attempts using the improved genetic algorithm described earlier without achieving a better result, the corresponding position will be considered as the optimal placement at this stage. FIG. 10D shows the final optimized position of the expanded area of the pattern, corresponding to the pattern's position shown in FIG. 10(e), thereby maximizing the overlap ratio.

### (3) Placement of the First Pattern

The order of pattern arrangement depends on two key factors: the size of the pattern and the overlap ratio of the pattern's expanded area. Initially, the order of the patterns is determined solely based on their size. However, the overlap ratio of the first pattern may not be the highest. To address this discrepancy, the top Nₘₐₓ (set to 10 here) patterns in the sequence are selected, and any patterns smaller than α (set to 0.75 here) times the size of the first pattern are excluded. The corresponding conditional expression is as follows:

$$\{ \begin{matrix}{I}^{′} = sort ( I , descend by s ( i ) ) \\ {I}_{top 10} = first ( {I}^{′} , 10 ) \\ {I}_{final} = \{ {i}_{k} ∈ {I}_{top 10} \vert s ( {i}_{k} ) ⩾ α \cdot s ( {i}_{1} ) \}\end{matrix} \qquad ( 18 )$$

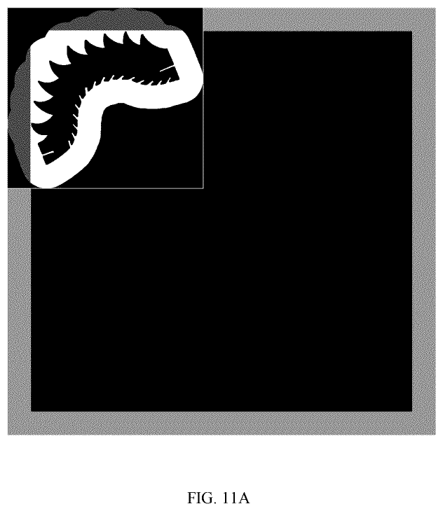

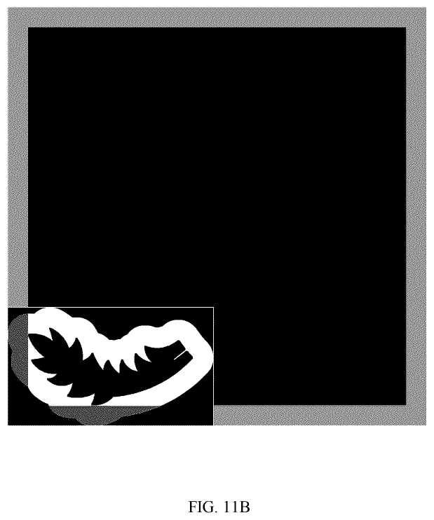

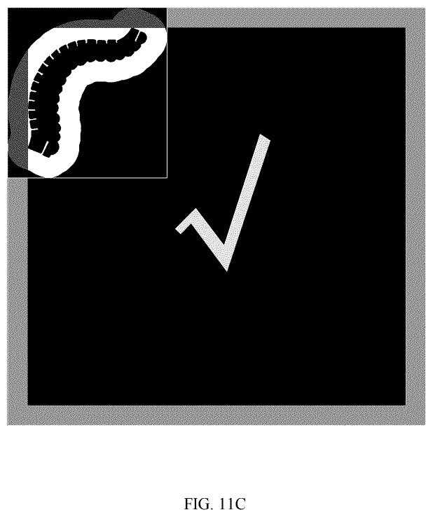

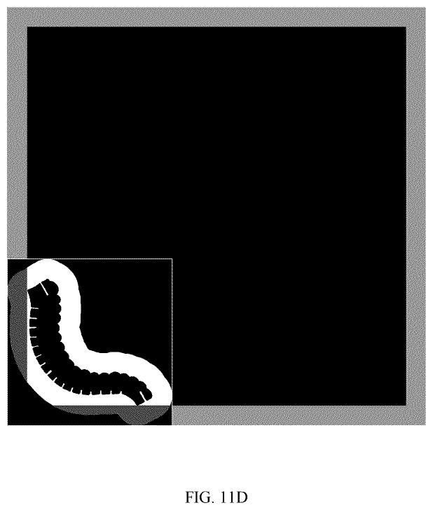

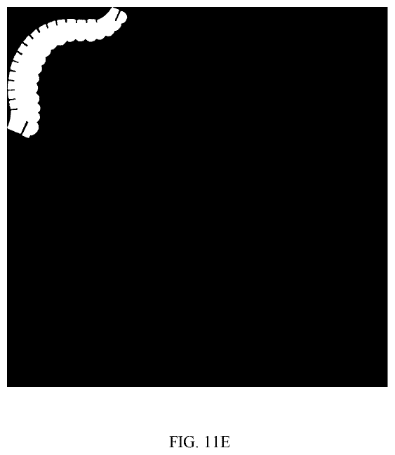

According to Formula (18), only the top four patterns are ultimately selected. The positions of these selected patterns are optimized using the improved genetic algorithm, as shown in FIG. 11A-FIG. 11D. Among them, the expanded area of the third pattern is identified as having the highest overlap ratio, as illustrated in FIG. 11C. This corresponds to the position of the pattern shown in FIG. 11E, and it is determined to be the first pattern placed on the plate.

### (4) Placement of Subsequent Patterns

So far, only the placement of the first pattern has been completed. The pattern already placed on the plate is removed from the pattern sequence. Using the same selection criteria, another group of patterns is selected; from this group, three patterns are ultimately identified for further evaluation and placement.

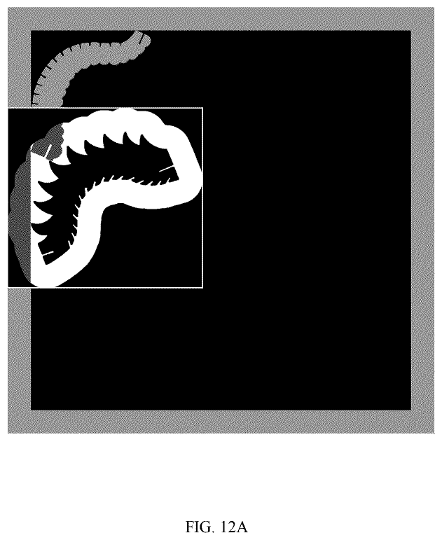

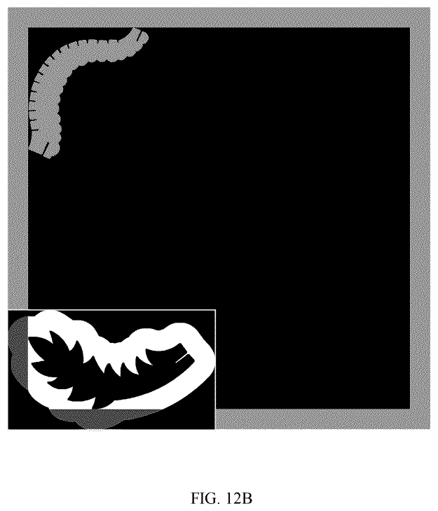

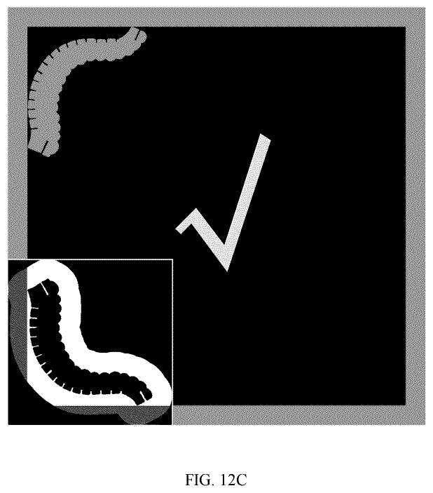

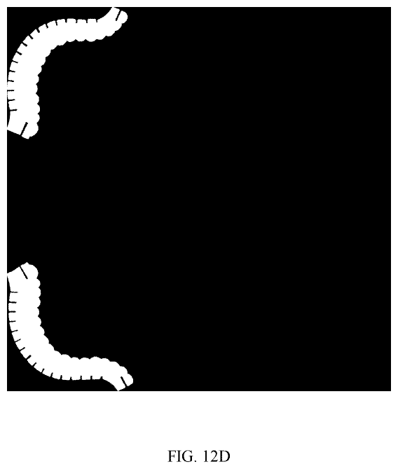

Before placing the initial pattern, the plate image remains unoccupied, and the expanded area of the pattern image can only overlap with the expanded area of the plate. However, for subsequently arranged patterns, their expanded areas can overlap with not only the expanded area of the plate but also the pattern images that have already been arranged on the plate. The overlapping areas are shown in dark gray, as illustrated in FIG. 12A-FIG. 12C.

Ultimately, the expanded area of the pattern shown in FIG. 12C is identified as having the highest overlap ratio. This corresponds to the position of the pattern shown in FIG. 12D, completing the placement of the second pattern.

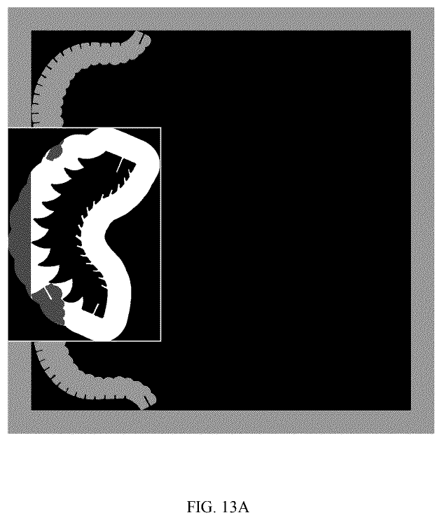

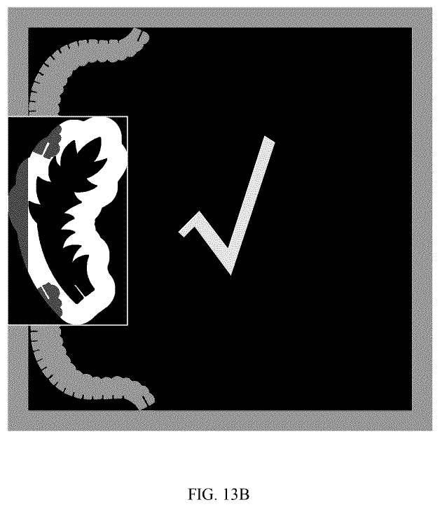

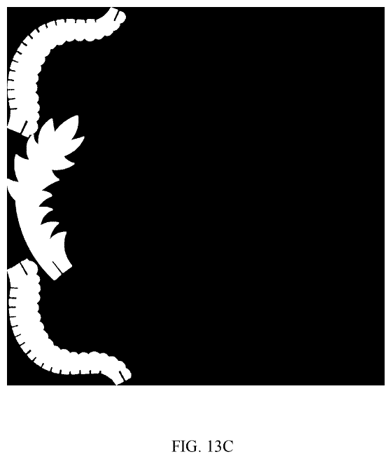

Using the same method, FIG. 13A-FIG. 13C illustrates the placement process of the third pattern. The final placement result is presented in FIG. 13C, which includes the arrangement of the first three patterns.

### (5) Left-to-Right Arrangement Principle

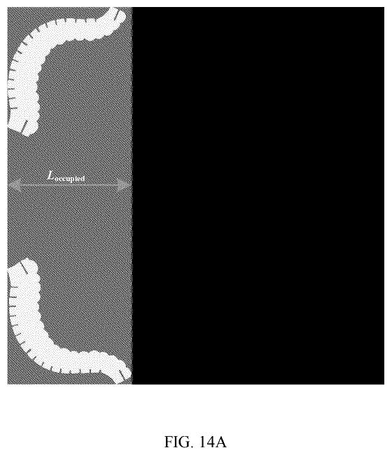

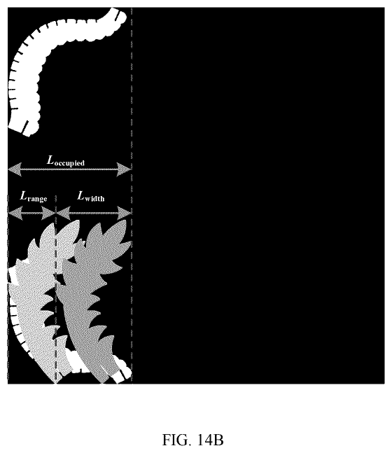

The pattern arrangement process follows a left-to-right principle, starting from the already occupied area, as shown in FIG. 14A. The currently occupied area is the part to the left of the dashed line. When placing the third pattern, the focus is on positioning it within these predefined boundaries to avoid increasing the already utilized width. As shown in FIG. 14B, the pattern in light gray represents the leftmost boundary where placement is possible, while the pattern in dark gray on the right indicates the rightmost boundary for placement. This method ensures that the third pattern fits within the area defined by the L_{occupied} constraint, effectively utilizing space without expanding the occupied area.

According to FIG. 14B, the formula for calculating the width of the search area for the third pattern is as follows:

$${L}_{range} = {L}_{occupied} - {L}_{width} \qquad ( 19 )$$

The x-coordinate for placing the third pattern is determined by the following expression:

$${x}_{3} = BIN ( 1 : 12 ) \cdot ( {L}_{occupied} - {L}_{width} ) / 4096 \qquad ( 20 )$$

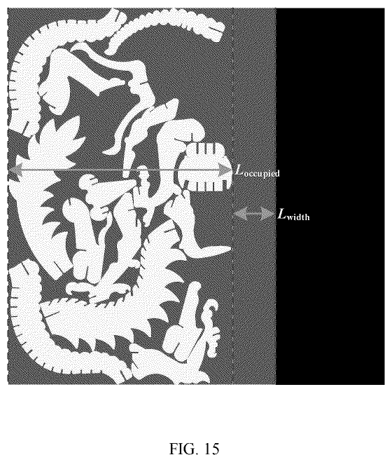

It is evident that a suitable position for the third pattern can be found within the width-constrained area L_{occupied}, as shown in FIG. 14A. However, this can occasionally be challenging. As illustrated in FIG. 15, within the framework of the improved genetic algorithm, the constraint of L_{occupied} may make it difficult to find the ideal position for the current pattern, although opportunities for appropriate placement may still exist.

To overcome this difficulty, the overlapping areas of all samples are determined, and the position with the least overlap is considered the most suitable for placing the pattern. As a result, the codes of all samples are updated to match the code of the sample with the minimum overlap. Subsequently, a mutation operation is performed on these codes. If a sample indicates that the pattern position is identified without overlapping with any other pattern, the optimization sequence outlined in FIG. 8 is initiated. However, in some cases, finding a suitable position for the pattern remains challenging. In such cases, the search area width specified for the current pattern will be expanded by L_{width}, which corresponds to the width of the pattern, as shown in FIG. 15.

As the occupied width expands, increasing the number of samples in the genetic algorithm is essential for improving the chances of finding the optimized position for the pattern. The required number of samples is calculated based on the given formula:

$${N}_{sample} = ⌈ {L}_{occupied} / 50 ⌉ \cdot 80 \qquad ( 21 )$$

The symbol ‘┌ ┐’ represents the ceiling function in mathematics, which rounds a number up to the nearest integer.

### (6) Pseudo-Code of Typesetting Framework

The pseudocode for the corresponding packing process is as follows:

```
1. SortPatternsBySizeDescending( )
2. patternsSelected = SelectFirstNPatterns(Nₘₐₓ)
3. for k = 1 to Nₘₐₓ do
  a. InitializePopulation( )
  b. isBetterResultFound = false
  c. mutationAttempts = 0
  while mutationAttempts < 5 AND NOT isBetterResultFound do
    i. for each individual in population do
      - if CheckForOverlapping(individual) then
        * IncreaseSearchAreaWidth( )
        * overlapSize = CalculateOverlapSize(individual)
        * if overlapSize < currentBestOverlapSize then
          currentBestCode = individual.code
          currentBestOverlapSize = overlapSize
        end if
      - else
        * coverage = CalculateCoverage(individual)
        * if coverage > currentBestCoverage then
          currentBestCode = individual.code
          currentBestCoverage = coverage
          isBetterResultFound = true
        end if
      end if
    end for
    ii. if NOT isBetterResultFound then
      mutationAttempts += 1
      PerformMutationOperation( )
    else
      mutationAttempts = 0
    end if
  end while
  d. OptimizePatternPosition(currentBestCode)
  e. CalculateOccupiedExpandedAreaRatio( )
  if k < Nₘₐₓ then
    f. RemoveOptimizedPatternFromCollection( )
  end if
4. end for
5. if CollectionIsEmpty( ) then
  FinishPackingProcess( )
163. end if
164. Packing result.
```

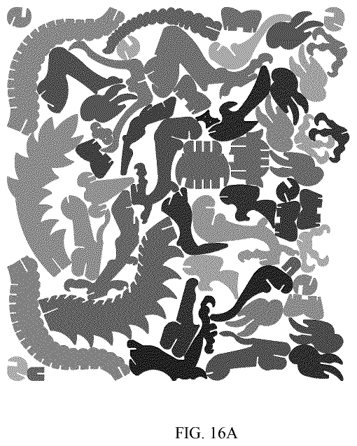

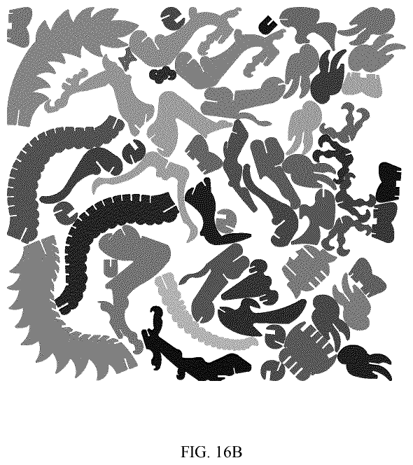

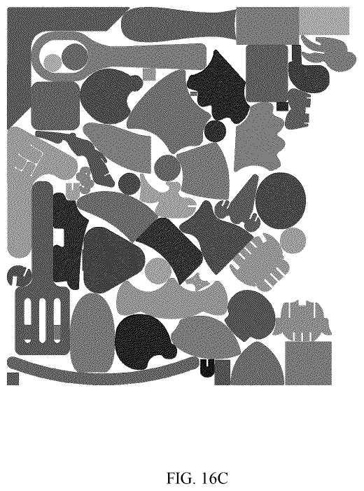

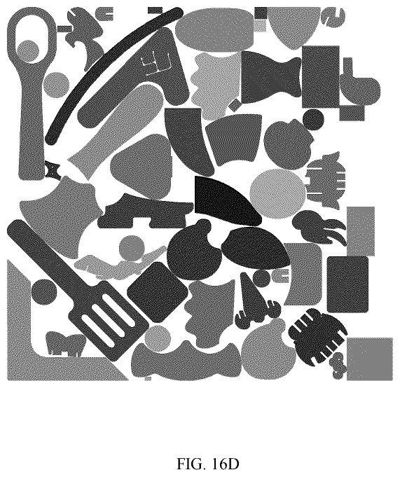

To highlight the superiority of the Iterative Overlap Optimization Placement (IOOP) method proposed in this disclosure, FIG. 16A-FIG. 16D presents a comparative analysis between IOOP and non-iterative overlap optimization placement methods.

It can be observed that, compared to pattern arrangement methods purely based on size order, the dynamic iterative process of IOOP further improves material utilization.

The disclosed preferred embodiments of present disclosure are provided to illustrate the disclosure. The preferred embodiments do not exhaustively describe all details nor do they limit the disclosure to the specific implementations described. It is evident that many modifications and variations can be made based on the content of this specification. These embodiments are selected and specifically described to better explain the principles and practical applications of the disclosure, enabling those skilled in the art to fully understand and utilize the disclosure. The present disclosure is limited only by the scope of the claims and their full range of equivalents.

What is claimed is:

1. A method for efficient packing of two-dimensional irregular patterns via expanded areas overlap optimization and dynamic iteration, comprising following steps:
S1, extracting pattern images of parts from computer aided design (CAD) drawings, and converting the pattern images to a binary format, wherein black represents background and white represents a part area;
S2, obtaining transverse dimensions (Lₕ) and longitudinal dimensions (Lᵥ) of the parts;
S3, sorting the pattern images from largest to smallest based on a sum of the transverse dimensions (Lₕ) and the longitudinal dimensions (Lᵥ) of the parts, denoted as Lₜ;
S4, expanding the pattern images for a first time based on gap requirements between the parts;
S5, calculating a width value w₂ of a corresponding expanded area based on the longitudinal dimensions (Lᵥ) and the transverse dimensions (Lₕ) of the parts, and expanding the pattern images for a second time;
S6, selecting top N pattern images as a group of images based on a predetermined value Nₘₐₓ and a corresponding dimensional principle;
S7, expanding a plate image by a same width (w₂) as a corresponding pattern image before a packing optimization process for each of the pattern images;
S8, employing a modified genetic algorithm to encode, mutate, and decode placement positions of each of the pattern images within a selected group onto the plate image, and calculating an overlap rate between the expanded area from a second expansion of a current pattern image, the expanded area of the plate image, and any already arranged pattern images;
S9, selecting a pattern image with a highest overlap rate and packing the pattern image on the plate image in a specified optimized position, then removing the pattern image from a previous image sequence; and
S10, repeating steps S6-S9 until all the pattern images have been arranged on the plate image.

2. The method for efficient packing of two-dimensional irregular patterns via expanded areas overlap optimization and dynamic iteration according to claim 1, wherein in the step S5, the corresponding dimensional principle is: the dimension Lₜ of a smallest part in each selected group of pattern images is not less than α times a dimension of a largest part in the group.

3. The method for efficient packing of two-dimensional irregular patterns via expanded areas overlap optimization and dynamic iteration according to claim 1, wherein in the step S5, after arranging each image, a new group of pattern images is selected, and the overlap rate of the expanded area for each image in the new group is recalculated.
